(19) United States
(12) Patent Application Publication
(10) Pub. No.: US 2010/0241850 A1
(43) Pub. Date: Sep. 23, 2010

(54) HANDHELD MULTIPLE ROLE ELECTRONIC AUTHENTICATOR AND ITS SERVICE SYSTEM

(76) Inventor: Chuyu Xiong, Jericho, NY (US)

Correspondence Address: SCULLY SCOTT MURPHY & PRESSER, PC, 400 GARDEN CITY PLAZA, SUITE 300, GARDEN CITY, NY, 11530, US

(21) Appl. No.: 12/405,707

(22) Filed: Mar. 17, 2009

(51) Int. Cl. H04L 9/32; H04L 9/00

(52) U.S. Cl. 713/155; 713/168

(57) ABSTRACT

The present invention provides a handheld electronic authenticator and its service system that provide multiple dynamic authentication codes for authenticating with multiple service providers. The authenticator provides multiple dynamic authentication codes (e.g., including electronic signatures) for the multiple service providers, using an algorithm, secret key and dynamic variables chosen and maintained by the service provider.

### FIELD OF THE INVENTION

The present invention generally relates to an authentication device and service system, and more specifically to a handheld multi role electronic authenticator and system providing multiple authentication codes for authenticating with multiple service providers.

### BACKGROUND OF THE INVENTION

In modern society, everyone is associated with several identifications (IDs). For example, a person has a social security number, bank accounts, credit cards, web accounts etc. Oftentimes, the person's IDs contain confidential information that the user wishes to keep in secret and only discloses to trusted parties in facilitating transactions, such as paying bills, purchasing goods, etc. Frequently, in order to conduct a transaction, a person needs to disclose his/her IDs to parties that s/he is not familiar with or even does not know. Moreover, even when conducting transactions with trusted parties, the uses may only be able to communicate through vulnerable unsecured communication channel subject to outside attacks such as hacking. Leaking confidential information on the IDs may bring severe consequences such as loss of privacy or identity fraud.

Methods of authentication of a person's identity have been proposed to protect confidential information of a person in business transactions. Standards based on differentiating the ways of authenticating have been categorized. The authentication may be based on what a person has, e.g. a token, what a person knows, e.g. a password, what a person is, e.g. a fingerprint, or what a person is related to, e.g. a social network.

An example of authentication on what a person has is an authentication method based on a one-time authentication code (OTAC) provided by a device that the person holds. The OTAC is an unpredictable dynamic code that is only temporarily valid and changes value when a time period has elapsed (time-based) or an event has happened (event-based). That is, a particular code generated by the device is valid only once. The OTACs are desirable in reducing security risks when the code is disclosed to an unknown party or over an unsecured communication channel, because the OTACs tend to limit the risk of leaking confidential information to one transaction without affecting subsequent transactions. During authentication, an authenticator generates the OTAC and transmits the code to a server which compares the OTAC to another code computed by the server using a same algorithm and inputs. A shared secret key known to both the authenticator and the server is a critical input in generating the codes and prevents others from predicting the OTAC. In the prior art, the secret key in the authenticator is set by the manufacturer, which entails the manufacturer's knowledge of the secret. However, the manufacturer's knowledge of the secret key provides a chance for compromising the secret key. Furthermore, in the prior art, an authenticator may only share the secret key with one service provider to limit any damage brought by the compromise of the secret key. Thus, a user has to inconveniently carry multiple authenticators to work with multiple service providers.

Depending on the number of the different ways of authentication combined in one authentication system, there are so-called 2-factor, 3-factor or 4-factor authentication systems. For example, an authentication system requiring a token and a password is a 2-factor authentication system, a system requiring a token, a password and a fingerprint is 3 factored, and a system further requiring a social network validation is a 4-factor system. Generally, the more factors an authentication system incorporates, the more secured it is. Current technology provides multiple factored authentication systems based on a device providing OTAC and other factors such as a password or a fingerprint. However, in the current authentication systems, other factors are not integrated with the OTAC. That is, an authentication server in the current authentication systems can only authenticates the OTAC factor but not other factors. Therefore, there is a need for an integrated approach in an authentication system to authenticate multiple factors.

### SUMMARY OF THE INVENTION

The present invention provides an authenticator and a system generating OTACs with secret keys only shared by the authenticator and the service providers. The present invention also provides an authenticator generating multiple OTACs that can be securely used with multiple service providers based on different secret keys. Furthermore, the present invention provides a system that supports transactions using a public name of a foil and/or the public name of authenticator, and the OTAC, which does not require disclosure of the confidential information of the user.

According to one embodiment of the present invention there is provided a handheld electronic multi-role identification authenticator providing a plurality of dynamic authentication codes associated with a plurality of service providers including a keypad unit operable to receive key inputs; a display unit operable to display codes; a plurality of foils, each foil storing a first secret key, a first communication key, and a plurality of dynamic variables; and a computing unit operable to generate a plurality of dynamic authentication codes in accordance with a predetermined algorithm, each dynamic authentication code generated based on the first secret key and the dynamic variables stored on one of said foils.

According to another embodiment of the present invention there is provided A method of authenticating using a handheld electronic multi-role authenticator associated with a plurality of service providers, comprising including generating a secret key and transmitting the secret key to the authenticator; maintaining a plurality of dynamic variables in the authenticator;

receiving from the authenticator a first dynamic authentication code generated based on the dynamic variables and the secret key using a predetermined algorithm; generating a first dynamic verification code generated based on the dynamic variables and the secret key using the predetermined algorithm; comparing the first dynamic authentication code to the first dynamic verification code; and determining authenticity based on a result of the comparison.

According to still another embodiment of the present invention there is provided A method of authentication for conducting a transaction using a handheld electronic multi-role authenticator associated with a plurality of service providers, including providing a dynamic authentication code associated with a service provider; providing a public name associated with the authentication code; identifying a server of the service provider based on the public name; and authenticating the dynamic authentication code with the identified server of the service provider.

### BRIEF DESCRIPTION OF THE DRAWINGS

The foregoing objects and advantages of the present invention may be more readily understood by one skilled in the art with reference to the following detailed description of several embodiments thereof, taken in conjunction with the accompanying drawings wherein like elements are designated by identical reference numerals throughout the several views, and in which:

FIGS. 1A-1D are views of several designs of the handheld electronic authenticator;

FIG. 2 is a block diagram of the logical design of the handheld electronic authenticator according to an embodiment of the present invention;

FIG. 3 is a block diagram of the read protected memory 255 and the RAM 265 in the memory system of the computing module 205 in FIG. 2;

FIG. 4 is a block diagram of the logical design of a foil of the handheld electronic authenticator according to an embodiment of the present invention;

FIG. 5 is a flowchart of a process of initiation/maintenance of the handheld electronic authenticator according to an embodiment of the invention;

FIG. 6 is a flowchart of a detailed process of initiation/maintenance that takes place in the server of authenticator;

FIG. 7 is a flowchart of a process of initiation/maintenance of a foil of the handheld electronic authenticator according to a preferred embodiment of the present invention;

FIG. 8 is a flowchart of a detailed process of initiation/maintenance that takes place in the server of service provider;

FIG. 9 is a flowchart of a process of identification authentication according to an embodiment of the present invention;

FIG. 10 is a flowchart of the detailed process of identification authentication;

FIG. 11 is a continued flowchart of the detailed process of identification authentication of FIG. 10;

FIG. 12 is a continued flowchart of the detailed process of identification authentication of FIG. 11;

FIG. 13 is flowchart of a process of signature generation according to an embodiment of the present invention;

FIG. 14 is a flowchart of a process using the handheld electronic authenticator to request service from service provider;

FIG. 15 is a flowchart of a process using the handheld electronic authenticator in a transaction with a 3^{rd} party; and

FIG. 16 is a flow chart of a process using the handheld electronic authenticator in a transaction with more data required by the service provider.

### DETAILED DESCRIPTION OF THE INVENTION

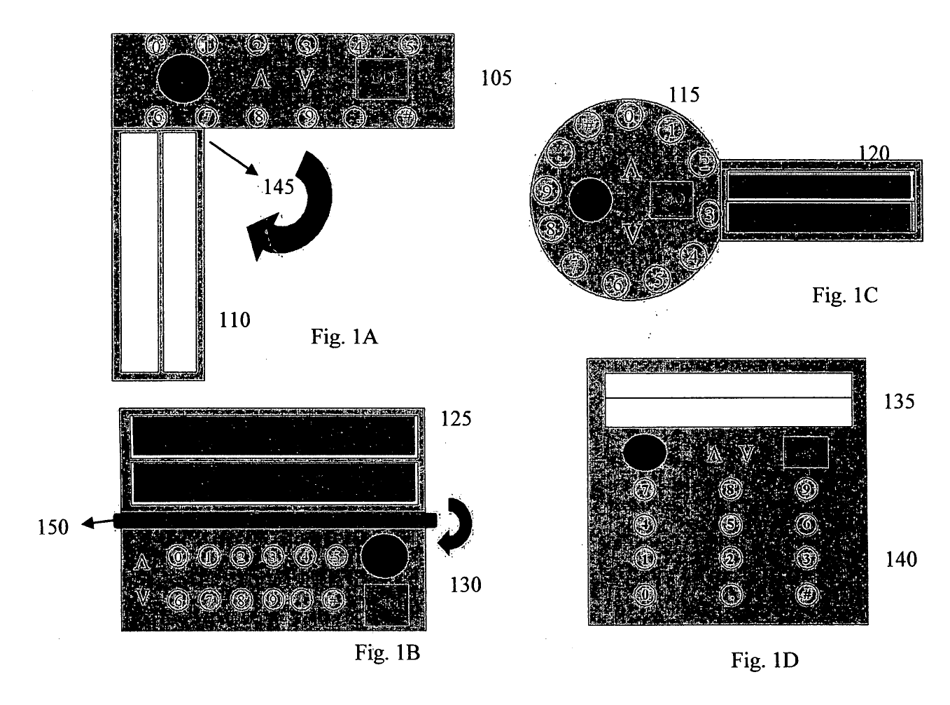

FIGS. 1A-1D are views of several designs of the handheld electronic authenticator. Referring to FIGS. 1A-1D, each design of the authenticator provides has a keypad (i.e. 105, 115, 130 and 140) having a plurality of keys receiving user inputs. The authenticators also have display units made of liquid crystal display (LCD) (i.e. 110, 120, 125 and 135). The unique feathers of the designs are as follows. Referring to FIG. 1A, the keypad 105 and the display unit 110 are rotatable around a common center point 145. In FIG. 1B, the authenticator is foldable along a lengthwise hinge 150 connecting the keypad unit 130 and the display unit 125. In FIG. 1C, the keypad 115 and the display unit 120 are made in one piece with a shape of a traditional key. In FIG. 1D, the authenticator takes a rectangular shape resembling a calculator.

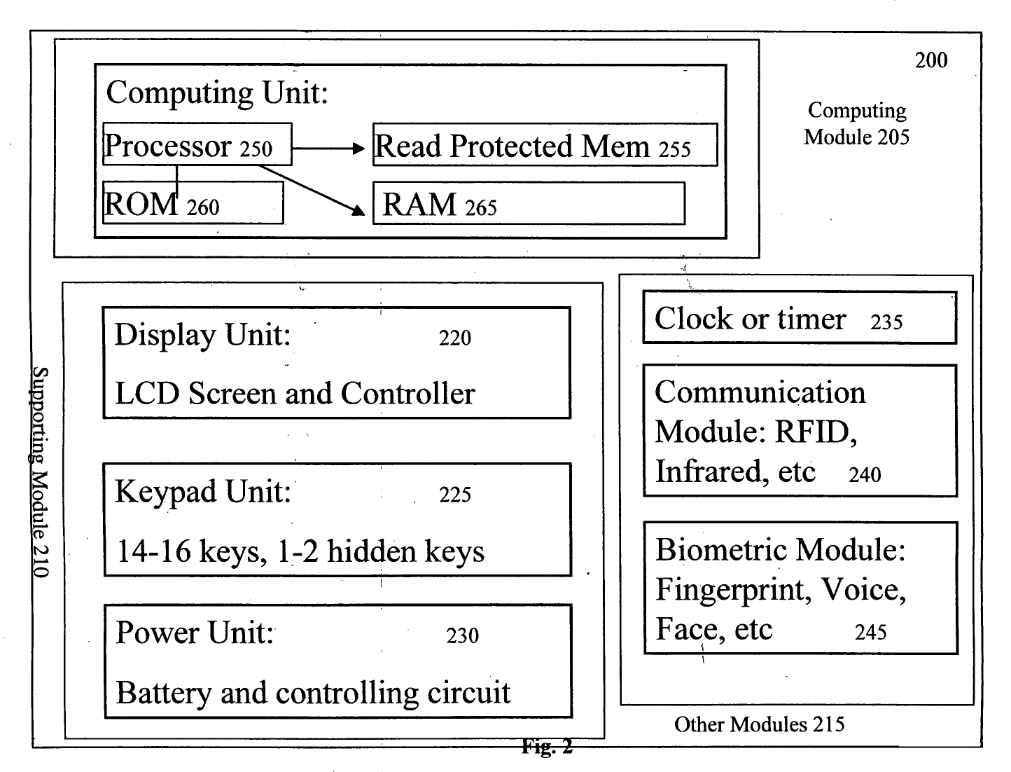

FIG. 2 is a block diagram of the logical design of the handheld electronic authenticator according to an embodiment of the present invention. Referring to FIG. 2, the authenticator includes a computing module 205, a supporting module 210 and other modules 215.

The computing module 205 contains a computing unit including a processor 250 for computing the authentication codes and a memory system for storing various data of the authenticator. The memory system includes a read/write protected memory 255 that protects the data from outside intrusion; a read-only memory (ROM) 260 storing static data; and a random access memory (RAM) 265 storing dynamic data generated in the process of authenticating. In addition to computing the various authentication codes, the computing module 205 executes other computational activities of the authenticator such as executing instructions, decrypting messages, etc., which will be described in more detail below.

The supporting module 210 provides support to the computing unit 205 in inputting/outputting data, supplying powers and other assistance for the authenticator to function properly. The supporting module 210 includes a display unit 220, e.g. an LCD screen and a controller therein for displaying data on the display unit 220; a keypad unit 225, e.g. a keypad having 14-18 keys and 1-2 hidden keys for inputting data; and a power unit that contains a battery and controlling circuit thereof.

Other modules 215 provide other functions that may be added to the authenticator. A clock or timer 235 provides a time keeping function. A communication module 240 provides transmission capacity to external devices based on communication technologies such as the radio frequency identification (RFID) or infrared technology. A biometric module 245 takes the biometrics of a user as inputs, such as a user's fingerprints, voice or facial features in combination with the authentication codes as an additional factor taken in consideration in the process of authenticating. The authenticator is extendable in that more functions can be added to the other modules 215. The modules may be implemented as hardware, software, or firmware components on the authenticator.

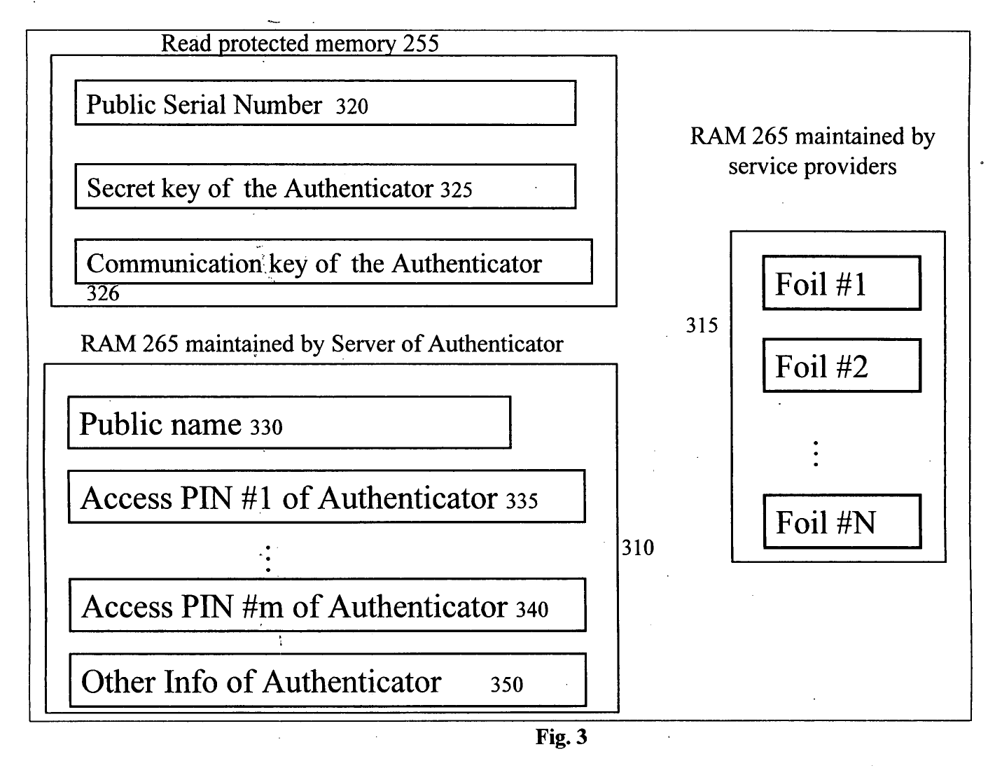

FIG. 3 illustrates the read protected memory 255 and the RAM 265 in the memory system of the computing module 205 in FIG. 2. As described above, the memory system may comprise a read/write protected memory 255, a ROM 260 and a RAM 265. Referring to FIG. 3, a public serial number 320, a secret key 325 of the authenticator and a communication key 326 are stored in the read protected memory 255 of the authenticator and are protected from outside intrusion. The public serial number 320, the secret key 325 and the communication key 326 are confidential information on the authenticator and is stored in the read protected memory 255 which cannot be read by external devices under normal condition even if snapped out of the authenticator.

The keys and numbers stored in the read protected memory 255 are set by the manufacturer of the authenticator during the manufacturing process of the authenticator. A server of the authenticator uses these keys and numbers to identify and provide services to the authenticator, i.e. initiation service and maintenance service. The server of the authenticator can be one provided by the manufacturer or an independent entity. To enable the communication between the authenticator and the server of the authenticator in one embodiment, before any service is rendered to the authenticator, the server of the authenticator obtains information on the keys and numbers regarding the authenticator from the manufacturer. The process of service will be described in more detail below.

The secret key 325 is used to generate the OTAC for authenticating with a server of the authenticator. The authenticator uses the communication key 326 to encrypt and decrypt data in communicating with the server of the authenticator using either a symmetric cryptology scheme or an asymmetric cryptology scheme determined by the server of the authenticator. When a symmetric cryptology scheme is chosen, the authenticator and the server of the authenticator use the same key to encrypt and decrypt messages communicated with each other. When an asymmetric cryptology scheme is chosen, the communication key is a private key of a public key and private key pair, where the pair is determined by the manufacturer. The authenticator uses the private key to encrypt and decrypt messages communicated with the server of the authenticator. The server of the authenticator uses the public key to encrypt and decrypt messages from the authenticator. The symmetric and asymmetric cryptology schemes are well known in the art and detailed descriptions thereof are omitted for conciseness.

Memory 310 stores dynamic data maintained by the server of the authenticator. For example, the server of the authenticator instructs authenticator to write to, change, and/or update the data in memory 310. In one embodiment, an entity that maintains the memory 310 (herein also referred to as “maintaining entity”), for example, the server of the authenticator, controls writing to and updating of the data in memory 310. In this embodiment, any entity other than the maintaining entity, including the user of the authenticator, cannot directly write to the memory 310. A user or another entity that wishes to change the memory 310 sends a request to the maintaining entity. For instance, the memory can be set by the user or another entity by requesting and receiving a code from the maintaining entity. This code may contain encrypted commands and data executable in the computing module 205 internally to set the memory.

The server of authenticator maintained memory 310 may include a public name 330 of the authenticator, several access personal identification numbers (PINs) 335-340, and other information are stored therein. The server of the authenticator sets the aforementioned information during the initiation and maintenance processes through commands and data sent to the authenticator. The initiation and maintenance processes will be described in more detail below.

Memory 315 stores a plurality of foils 1-N. Each of the foil in a working condition is set up to be exclusively associated with a service provider. The service providers are the entities that the authenticator provides OTAC to authenticate with. The service providers can be a credit card company, a bank, an online account etc. Each of the foil is maintained by its corresponding service provider. Each foil provides information necessary to generate the OTAC for the service provider it associates with. The authenticator can simultaneously provide as many OTACs as the number of foils. When a particular service provider is specified by the user, the authenticator will calculate the OTAC based on the information stored on the foil associated with the service provider. The generating of the OTACs will be described in more detail below.

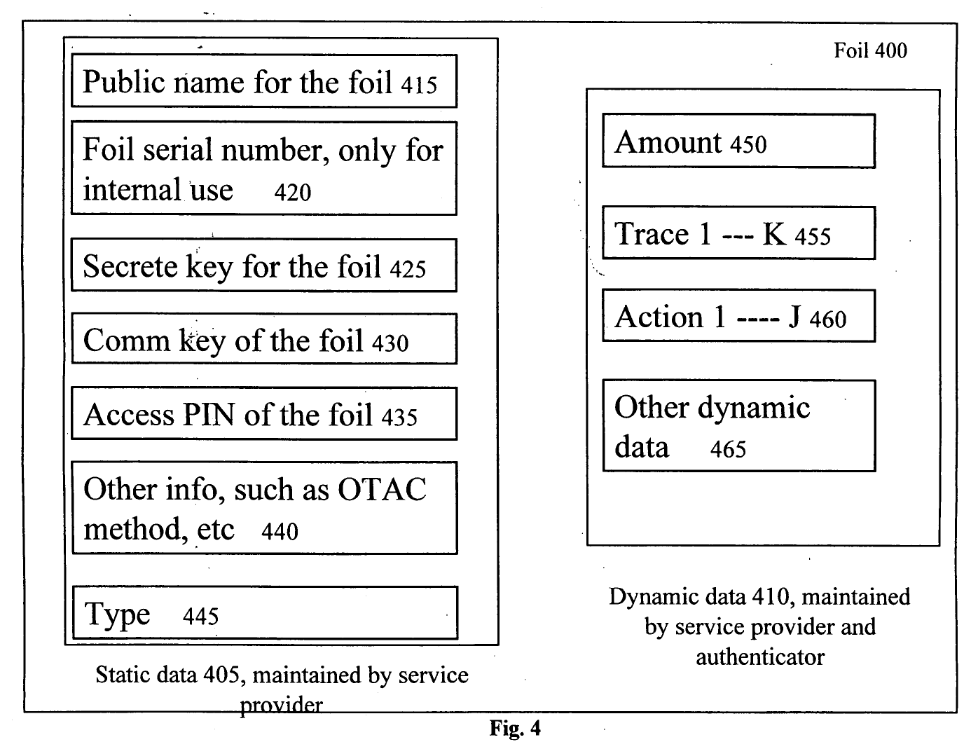

FIG. 4 is a block diagram illustrating the logical design of one of the foils 1-N 315 in FIG. 3 according to an embodiment of the present invention. Referring to FIG. 4, foil 400 includes static data 405 maintained by the service provider and dynamic data 410 maintained by the service provider and the authenticator. The static data 405 is exclusively maintained by the service provider associated with the foil. The static data 405 includes a public name for the foil 415, a foil serial number 420 for internal use, a secret key 425 of the foil, a communication key 430 of the foil, an access PIN 435, other information 440 and a type 445. The service provider sets static data during the association process through commands and data sent to the authenticator. The association process will be described in more detail below. The static data may be maintained/changed by service provider occasionally comparing to dynamic data that may change dynamically and frequently.

The dynamic data 410 maintained by the service provider and the authenticator includes an amount variable 450, such as a balance on a credit card when the service provider is a credit card company, a trace variable 455 which is a one-time variable that changes its value, an action variable 460 storing past actions taken with regard to the service provider, and other dynamic data 465 storing further information on the service provider. The dynamic data 410 is maintained both by the service provider and the authenticator. That is, both the service provider and the authenticator may write to the memory storing dynamic data 410. Meanwhile, the service provider maintains a copy of the dynamic data 410. When there is a change to the dynamic data 410 in either the authenticator or the service provider, the other copy will be updated accordingly when the authenticator is being maintained.

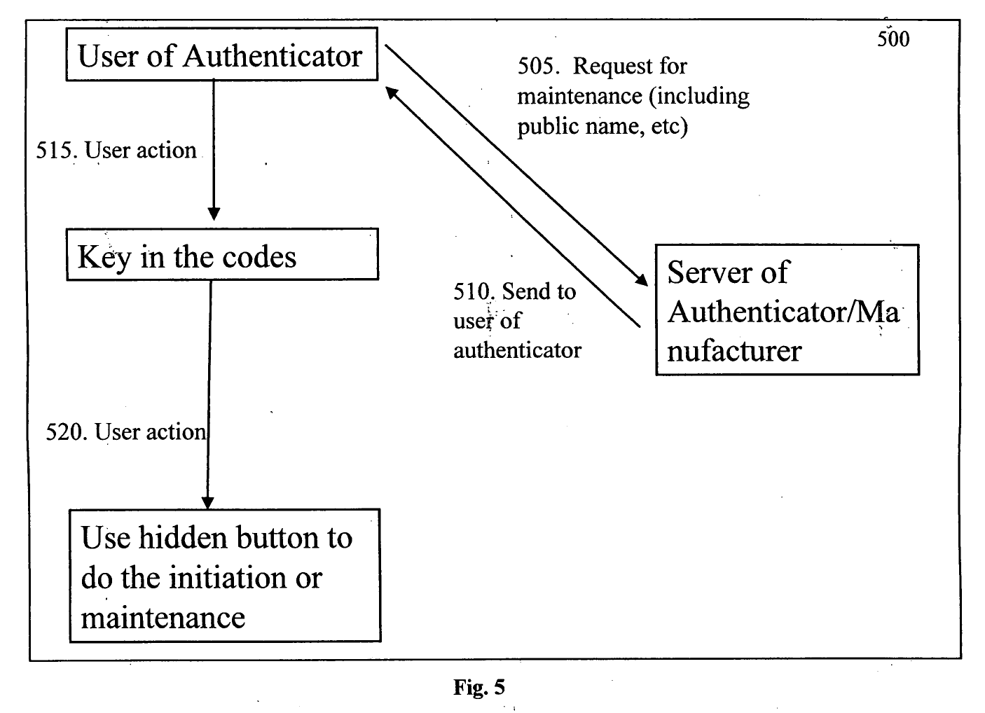

FIG. 5 is a flowchart of a process illustrating the process of maintenance of the handheld electronic authenticator according to an embodiment of the invention. As described above in FIG. 3, memory 310 is maintained by the server of the authenticator. When a user wants to update the items stored in memory 310, such as the public name 330 of the authenticator, a request must be sent to the server of the authenticator. Referring to FIG. 5, in step 505, the user of the authenticator sends a request to the server of authenticator. If the authenticator is authenticated by the server of the authenticator using a process similar to what is used to authenticate authenticator with a service provider, the server of authenticator will provide maintenance service to the authenticator. The process of authenticating with the service provider will be explained in more detail below. In step 510, the server of authenticator sends a code back to the authenticator providing relevant data requested by the authenticator. The code is encrypted using a cryptology scheme as describe above. In step 515, the user enters the encrypted code into the authenticator through a communication means, e.g. the keypad, or other means. In step 520, the user presses a key, e.g. a hidden key to initiate the internal maintenance of the authenticator. Receiving the signal from the hidden key, the authenticator decrypts the encrypted code and sets the data contained therein on the memory 310.

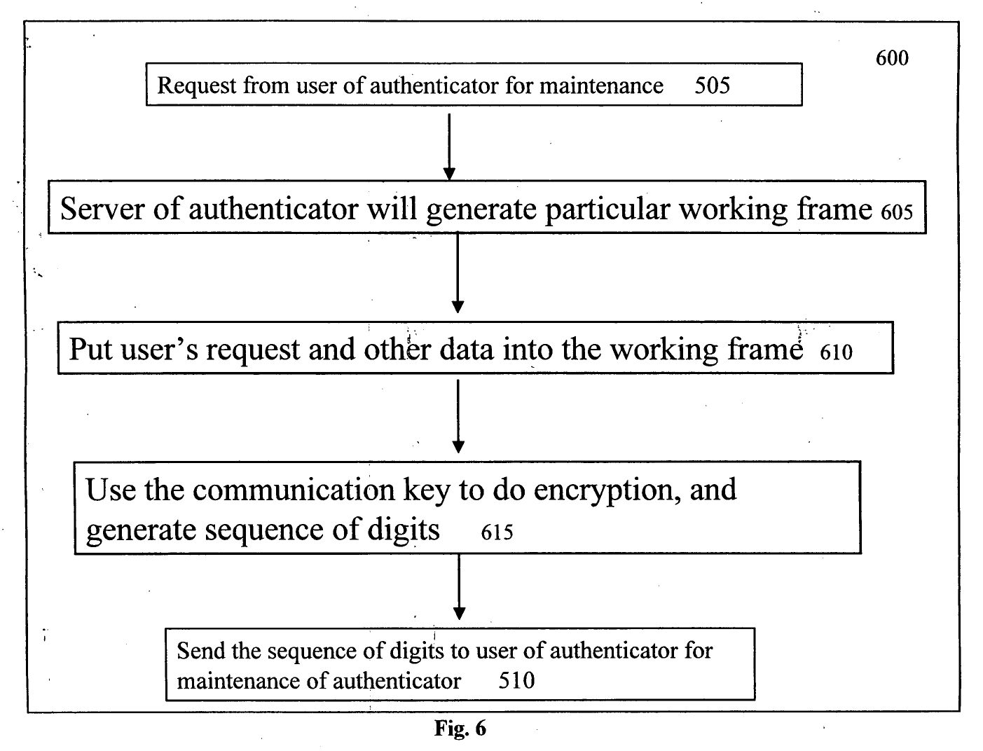

FIG. 6 illustrates the process taken inside the server of the authenticator from when the request for maintenance is received in step 505 till the code is sent out in step 510 in FIG. 5. Referring to FIG. 5, after receiving the request for maintenance from the authenticator, the authenticator will first authenticate whether this authenticator is an authorized device by checking the OTAC code generated based on the secret key 325 of the authenticator. The authentication process herein is similar to what is used in the service provider which will be described in more detail later. Thereafter, in step 605 the server of the authenticator will generate a working frame instruction. The working frame instruction contains maintenance data and command corresponding to the user's request for maintenance. In step 610, the server puts the maintenance data together according to the working frame instruction. In step 615, the server encrypts the frame using an encryption key associated with the authenticator according to the predetermined cryptology scheme and generates the code to be sent to the authenticator. Thereafter, step 510 will be executed according to the process described above in connection with FIG. 5.

An initiation process executed before the first use of the authenticator is similar to the maintenance process described above in connection with FIGS. 5-6. When the authenticator completes the initiation process, it is ready to be set up with service providers to provide the OTACs.

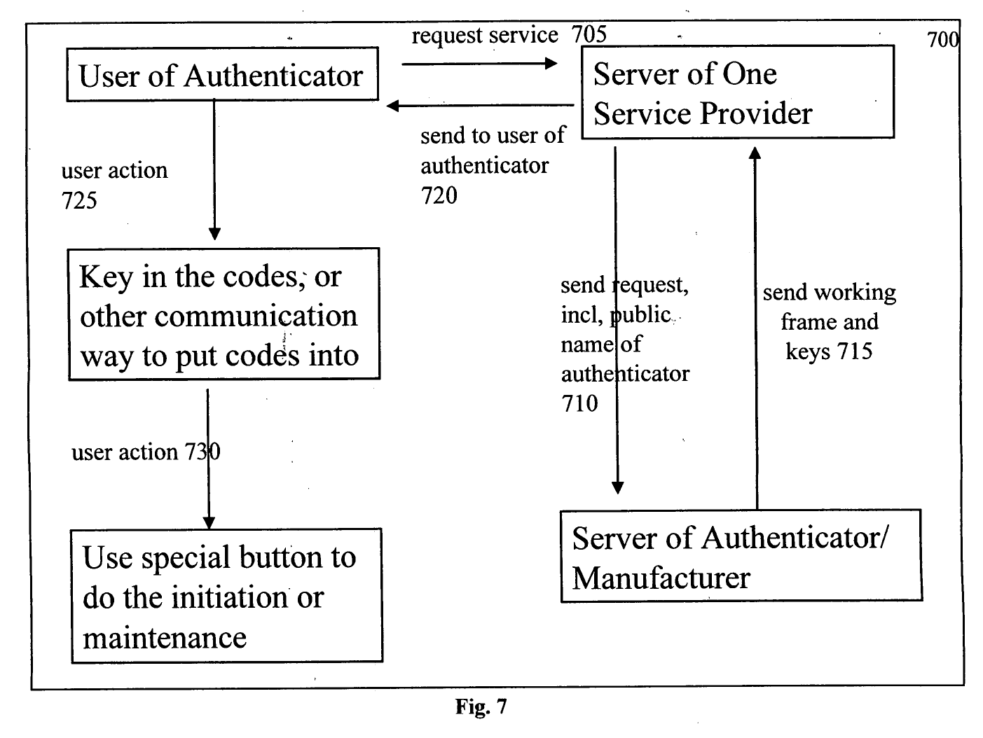

FIG. 7 is a flowchart of a process of maintenance of a foil of the authenticator according to an embodiment of the present invention. Referring to FIG. 7, in step 705 the authenticator sends a request to the service provider associated with the foil for maintenance. In step 710, the service provider sends a request to the server of the authenticator regarding the initiation and maintenance request from the authenticator. The request contains a name and other information of the authenticator to indicate the particular authenticator to the server of the authenticator. In responses the server of the authenticator sends a working frame instruction and keys of the authenticator back to the service provider in step 715. The working frame instruction contains data maintained by the server of the authenticator corresponding to the user's request for maintenance. The keys are 1) communication keys for encryption and decryption of the codes sent between the service provider and the authenticator, and 2) part of secret keys that will be combined with other parts to form secret key and secret communication key. The service provider processes the received information from the server of the authenticator and sends a code back to the authenticator in step 720. In step 725, the user enters the code through a communication means, e.g. the keypad. In step 730, the user presses a hidden key to initiate the internal maintenance of the foil. Receiving the signal from the hidden key, the authenticator decrypts the encrypted code, and combines the data obtained from the code with secret keys in the authenticator to form secret key and secret communication key of the foil, and sets the data contained therein on the foil.

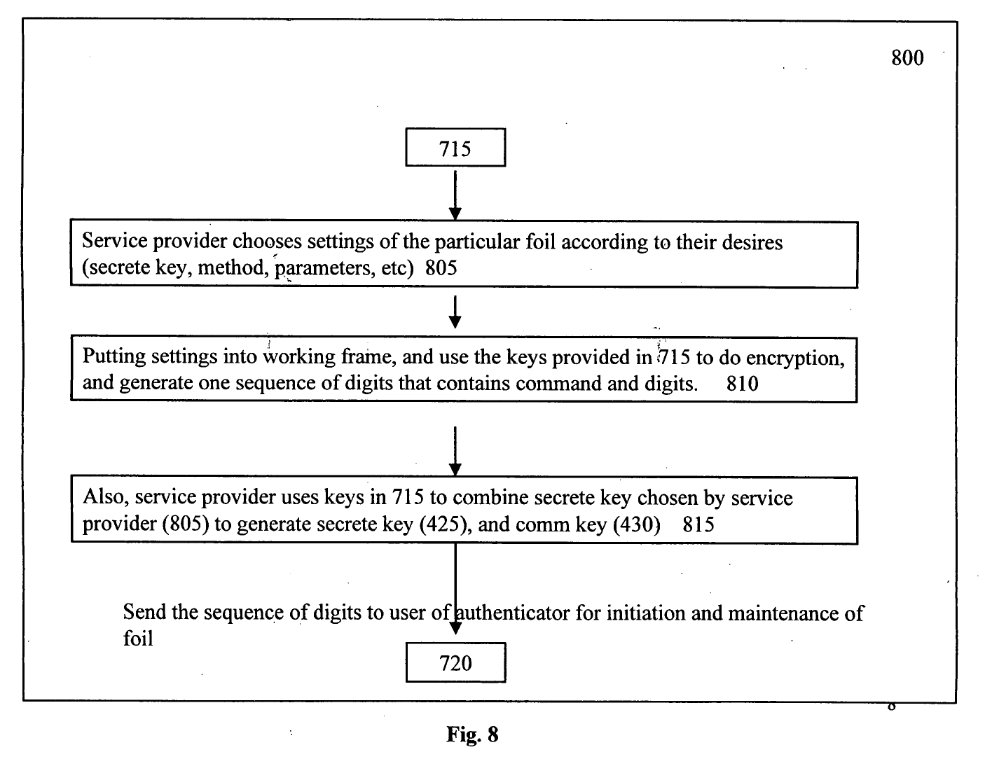

FIG. 8 illustrates the process taken inside the service provider after receiving the working frame file in step 715 for sending the code out in step 720 in FIG. 7. Referring to FIG. 8, after receiving the working frame file from the authenticator, the service provider chooses the settings for the particular foil in step 805. In step 810, the service provider puts data maintained by the service provider corresponding to the server's request into the received working frame file. In step 815, the server encrypts the frame file using the key received in step 715. According to the cryptology scheme chosen by the service provider, the server uses the key received in 715 to encrypt the frame file into a code comprising a sequence of digits. The cryptology scheme could either be a symmetric cryptology scheme or an asymmetric cryptology scheme. The code generated using the asymmetric scheme is longer than using the symmetric scheme but it also is more secure. The service provider can choose either scheme or others that best fits its purpose.

An initiation process to set up the association between the service provider and the authenticator is similar to the maintenance process described above in connection with FIGS. 7-8. When the authenticator completes the initiation process, it is ready to be set up with service providers to provide the OTACs.

Each foil is initiated and maintained using the same process described above in connection with FIGS. 7-8. After initiation or maintenance, the authenticator will be able to generate OTACs using the information set on the foils of the authenticator for authentication. The process of authentication with the service providers will be described in more detail below.

One advantage of the present invention is that the server of the service provider sets up the secret key 425 and the communication key 430 of the particular foil. The secret key 425 and the communication key 430 are information that is strictly kept confidential in order to make the OTACs unpredictable, thus preventing others such as hackers from simulating the codes. In current OTAC-based authentication systems, the manufacturer sets up and knows the keys in the authenticator. In the present invention, due to the design that the service provider sets up the keys, and in the foils, the manufacturer does not know the keys thus cannot predict the codes used between the authenticator and the service provider. This design is more secure than the current OTAC-based authentication systems because it eliminates the manufacturer from the system which could be a potential source for compromising the keys.

After the initiation or maintenance, the particular foil is successfully associated with the service provider and is ready to provide the OTACs for authentication. The authenticator can be used in authentication.

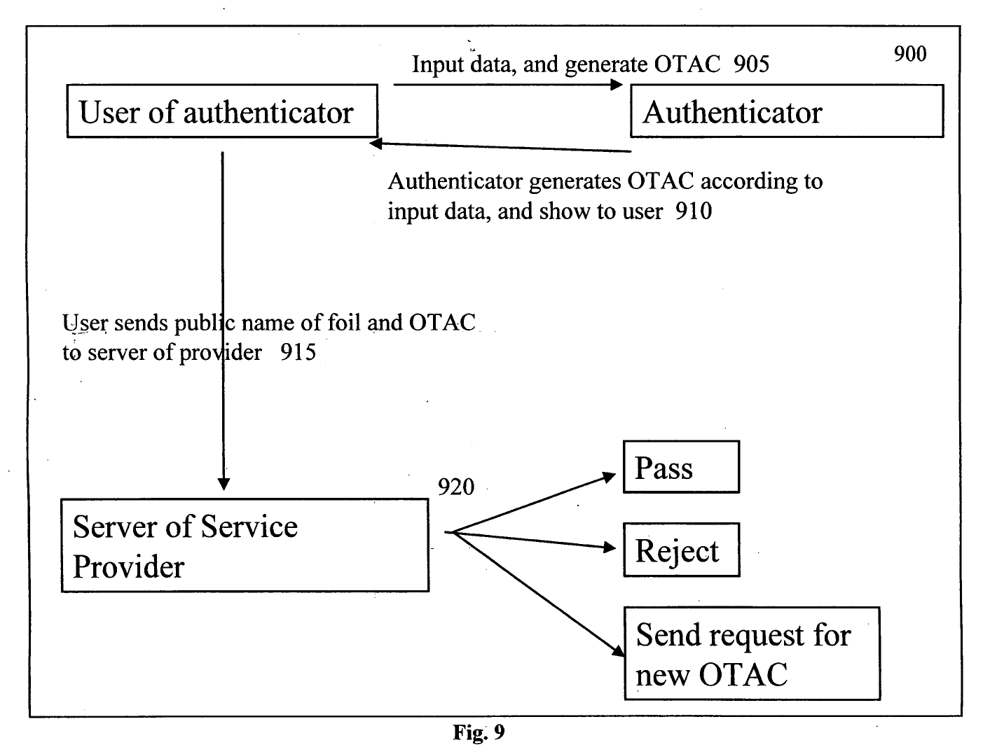

FIG. 9 is a flowchart illustrating the process of authentication according to an embodiment of the present invention. Referring to FIG. 9, in step 905 the user inputs data to indicate to the authenticator to request for an OTAC with respect to a service provider. In step 910, the authenticator generates the OTAC based on the information stored on the foil associated with the service provider. In step 915, the user provides the public name of the foil 415 associated with the service provider and the OTAC to the service provider for authentication. Step 915 may be accomplished by entering the OTAC into a website of the service provider through an authentication page or interface. In step 920, the service provider determines whether to grant authentication, deny authentication or send a request back to the authenticator for a new OTAC.

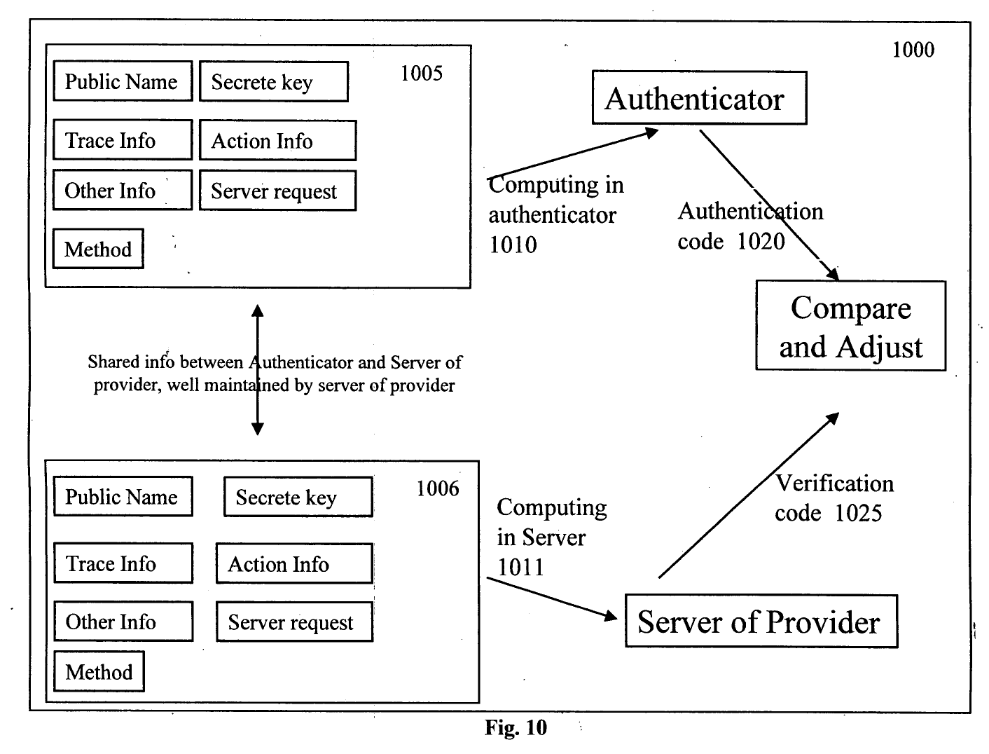

FIGS. 10-12 describe in detail the authentication process described in FIG. 9. An OTAC is generated as a function of multiple inputs to a predetermined algorithm. Referring to FIG. 10, as shown in 1005 and 1006, the inputs for generating the OTAC may include: the public name of the foil, the secret key, trace information related to a dynamic variable, action information regarding past actions taken on the foil, other information, server request, and a method. The inputs are both stored in the authenticator as illustrated in 1005 and in the server of the service provider as illustrated in 1006. Under an ideal working condition, the two sets of inputs 1005 and 1006 are identical. In steps 1010 and 1011, the authenticator and the service provider both generate OTACs based on inputs 1005 and 1006. The OTAC from the authenticator is an authentication code generated by the authenticator using one or more combinations of information shown in 1005 pending authentication. The OTAC from the service provide is a verification code independently generated by the service provider using one or more combinations of information shown in 1006 which is used to authenticate the authentication code. In steps 1020 and 1025, the authentication code and the verification code are compared to each other. For instance, the service provider compares the verification code with the authentication code received from the authenticator.

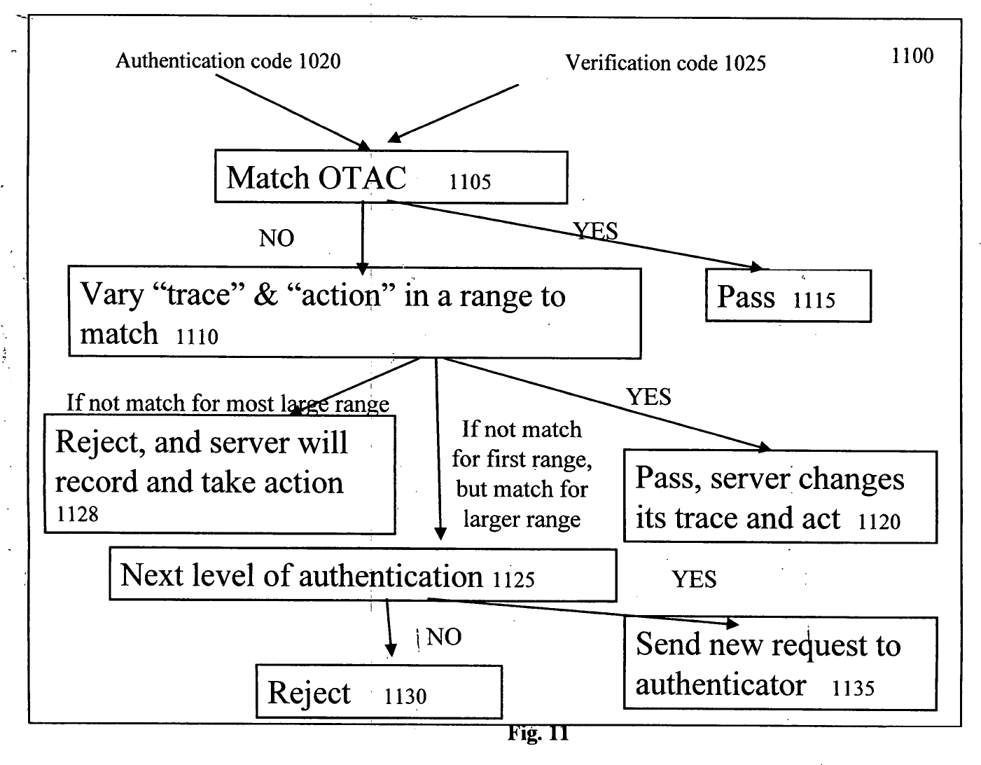

FIG. 11 is a continued flowchart from FIG. 10 farther describing the comparison steps of the authentication code and the verification code. Referring to FIG. 11, in step 1105, the authentication code and the verification codes are compared to each other. For example, the server compares the authentication code sent from the authenticator and received at the server of the service provider. If the two codes match, the server may authenticate the authentication code and grant the requested access to the user of the authenticator in step 1115. If the two codes do not match, the server will vary the trace input and the action input in a predetermined range and generate new verification codes in order to adjust for permissible inconsistencies between the trace inputs and the action inputs in the authenticator and the service provider. This step is taken because as described above, the trace input and action inputs are dynamic data both maintained by the authenticator and the service provider. In an ideal condition, the trace and action are identical in the authenticator and service provider. However, under normal working condition, many times the synchronization of the dynamic data are not timely updated or adjusted. Therefore, there may be small discrepancies. These discrepancies are permissible and accounted for in the present invention in one embodiment.

In step 1110, the newly generated verification codes within the predetermined range are further compared with the authentication code. If there is a match, the server will authenticate the authenticator in step 1120. If the authentication code is largely off range comparing to the verification code, the server will reject the request in step 1128. An authentication code may be determined as being largely off if it is outside threshold. The threshold is predetermined by the service server depending on its security policy. If the authentication code is neither largely off range nor correct, the server will conduct a next level of authentication in step 1125. After the next level of authentication, the service provider will decide whether to finally reject the request for authentication in step 1130 or send a request for new authentication code in 1135.

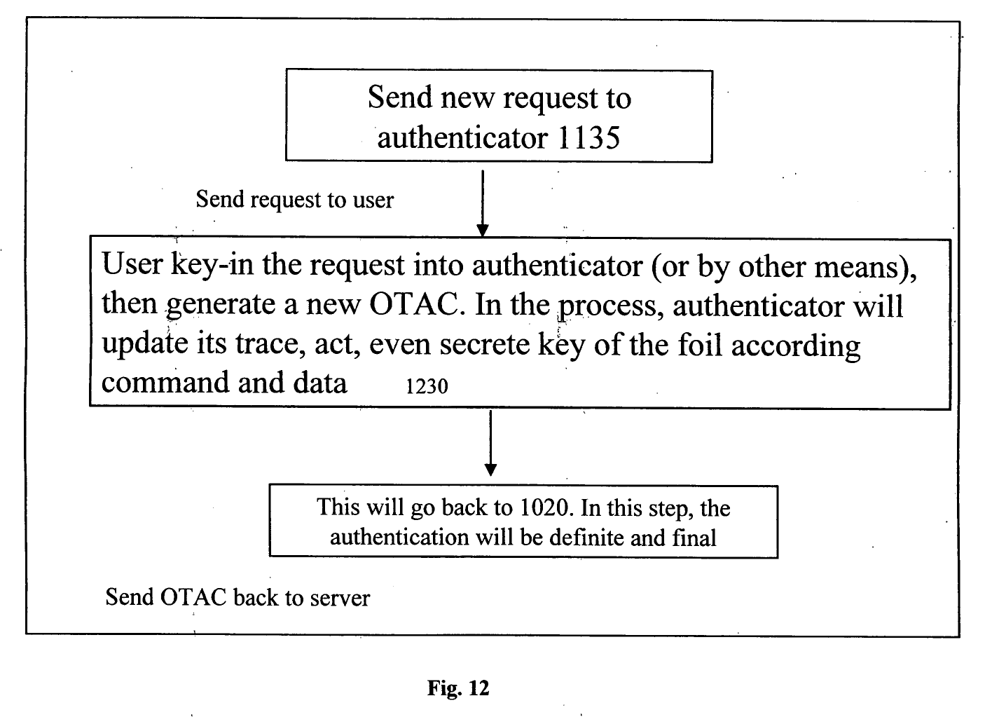

FIG. 12 is a continued flowchart from FIG. 11 further describing step 1135 of requesting a new authentication code. As described above, when the authentication code does not match the verification code but is not largely off, the service provider will send a request for a new authentication code. Referring to FIG. 12, when the authenticator receives a code comprising a request from the service provider, the user keys in or through other means inputs the code to the authenticator in step 1330. During this process, the authenticator generates a new authentication code with the new server request, trace and action inputs. Then, the authenticator resends the new OTAC to the service provider. In response to receiving the new authentication code, the new authentication code will be compared to a new verification code based on the new server request, trace and action inputs using the same steps as illustrated in FIG. 11.

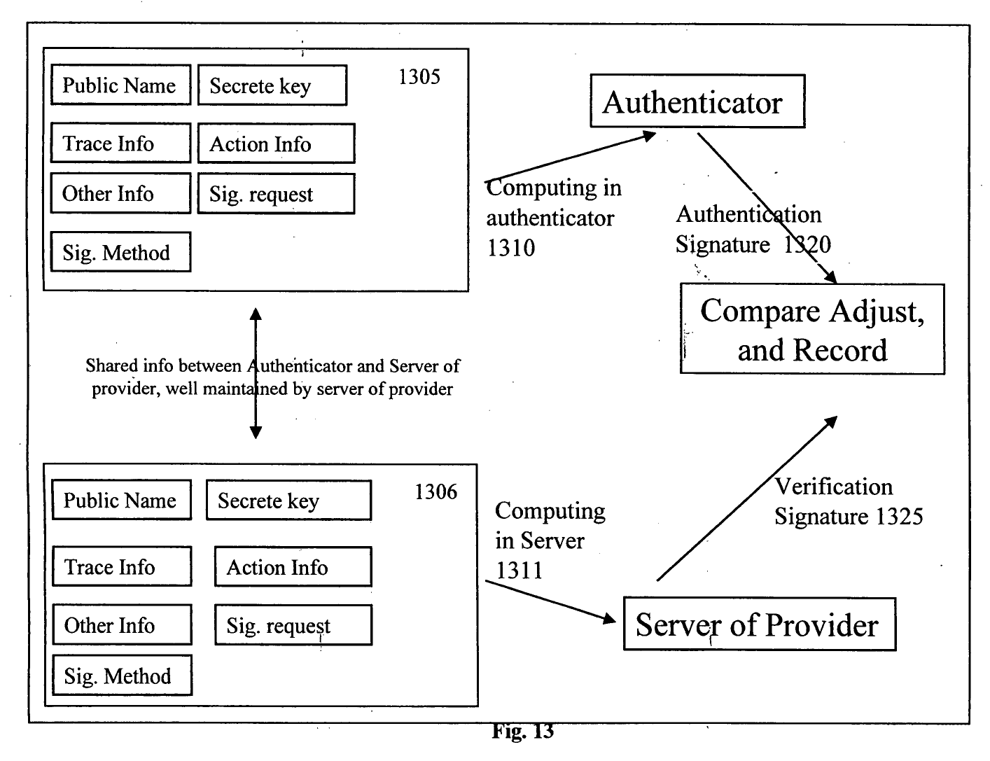

The authenticator may also be used to generate electronic signatures. The process in determining the authenticity of the signature is similar to what is described above in connection with FIGS. 10-12. FIG. 13 is flowchart of a process of signature generation according to the present invention. The inputs for generating the signature may include: the public name of the foil, the secret key, trace information related to a dynamic variable, action information regarding past actions taken on the foil, other information, signature request, and a signature method. Any combinations of several of the information may be used to generate the signature. The inputs are both stored in the authenticator as illustrated in 1305 and in the server of the service provider as illustrated in 1306. Under an ideal condition, the two sets of inputs 1305 and 1306 are identical. In steps 1310 and 1311, the authenticator and the service provider both generate signature OTACs based on inputs 1305 and 1306. The signature OTAC from the authenticator is a signature authentication code pending authentication. The signature OTAC from the service provide is a signature verification code used to authenticate the authentication code. In steps 1320 and 1325, the signature authentication code and the signature verification code are gathered together and compared to each other. For instance, the server compares the signatures. The process taken thereafter to authenticate the signature authentication code is identical to what is described in FIGS. 11-12. When the signature authentication code is authenticated, the signature is recorded and the underlying transaction is endorsed.

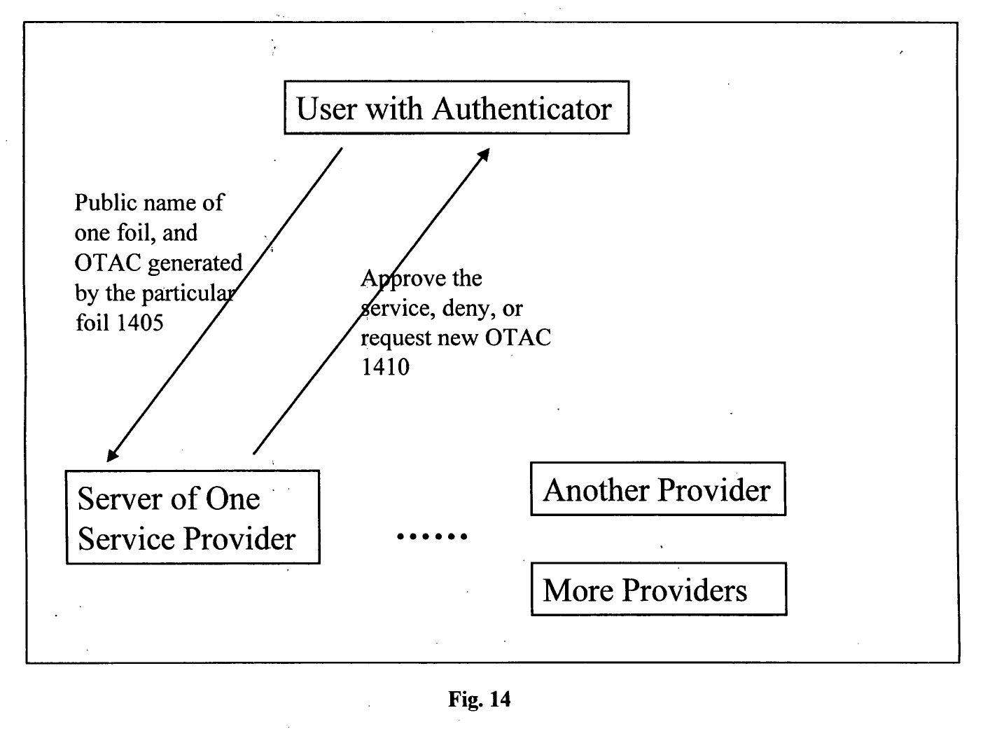

FIGS. 14-16 are flowcharts of processes using the handheld electronic authenticator in conducting transactions.

FIG. 14 is a flowchart of a process using the handheld electronic authenticator to request service from a service provider. Referring to FIG. 14, a user with authenticator using a public name on one foil and the OTAC generated therein to gain access to the service provider in step 1405. In step 1410, the service provider approves, denies or requests new OTAC, using the process described above in connection with FIGS. 10-13. Similarly, the user can gain access to all service providers, each associated with one of the foils of the authenticator. Using the OTACs in combination with the public name of the foil (associated with that service provider), the user can conduct business transactions with the service providers, but the confidential information is never disclosed during the process.

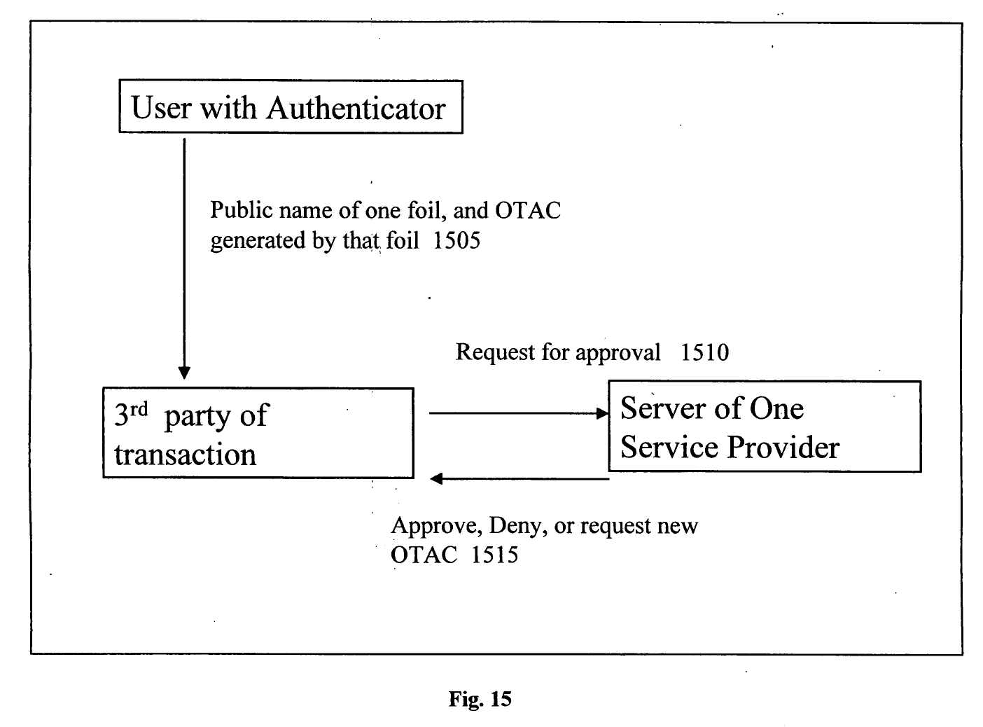

FIG. 15 is a flowchart of a process using the handheld electronic authenticator in a transaction with a 3^{rd} party. The 3^{rd} party is a party that the user of the authenticator deals with in transaction, for example a vendor. The 3^{rd} requires information from the user of the authenticator to conduct the transaction, for example a credit card number. Instead of giving the credit card number to the vendor, the user of the authenticator can give the public name of the foil and the OTAC to the 3^{rd} pay. This process is illustrated in FIG. 15. Referring to FIG. 15, the user of the authenticator provides the public name of the foil (associated with that service provider) and the OTAC thereof to a counter party of a transaction that requires confidential information, such as a bank account. In step 1505, the user provides the public name and OTAC to the counter party. The counter party request access to the service provider using the public name and OTAC in step 1510. In step 1515, the server of the service provide will approve, deny or request new OTAC as describe above in connection with FIGS. 1012. Since the OTAC is a dynamic variable, for example time-based, the counter party cannot gain access to the service provider after the time period that the OTAC is valid has lapsed.

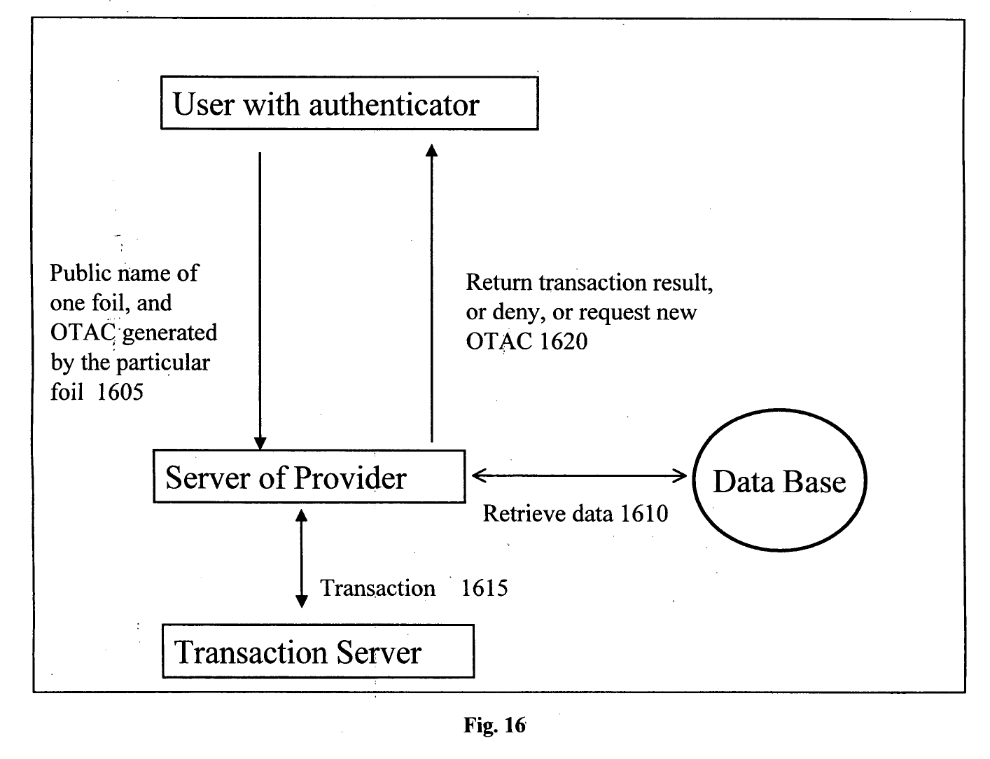

FIG. 16 is a flowchart of a process using the handheld electronic authenticator in a transaction with more data required by the service provider. Referring to FIG. 16, the user of the authenticator sends the public name and the OTAC of one foil to the server of service provider in step 1605. The server of the service provider retrieves more data from a database in step 1610. In step 1615, the server of service provider sends a traction request to a transaction server. In step 1620, the transaction result is either returned to the user if the authenticator was authorized or a request for a new OTAC or denial of access is returned.

As illustrated in FIGS. 14-16, during the transactions only a public name of a foil and the OTAC generated by the foil are used to gain access to the service provider. The confidential information, such as a credit card number or a social security code, is not disclosed. The public name of the foil (associate with that service provider) and the OTAC are used as a proxy for the confidential information when authentication is required for the transaction. This method provides convenience to the user for relieving the need of a user to memorize all his/her confidential information. It also provides better security in that the confidential information is not disclosed either to a third party or to a communication channel for gaining access to service providers.

Various aspects of the present invention may be embodied as a program, software, or computer instructions embodied in a computer or machine usable or readable medium, which causes the computer or machine to perform the steps of the method when executed on the computer, processor, and/or machine. A program storage device readable by a machine, tangibly embodying a program of instructions executable by the machine to perform various functionalities and methods described in the present invention is also provided.

The system and method of the present invention illustrated above in connection with FIGS. 1-16 may be implemented and run on a general-purpose computer or special-purpose computer system. The computer system may be any type of known or will be known systems and may typically include a processor, memory device, a storage device, input/output devices, internal buses, and/or a communications interface for communicating with other computer systems in conjunction with communication hardware and software, etc.

The terms “computer system” and “computer network” as may be used in the present invention may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, server. A module may be a component of a device, software, program, or system that implements some “functionality”, which can be embodied as software, hardware, firmware, electronic circuitry, or etc.

The embodiments described above are illustrative examples and it should not be construed that the present invention is limited to these particular embodiments. Thus, various changes and modifications may be effected by one skilled in the art without departing from the spirit or scope of the invention as defined in the appended claims.

What is claimed is:

1. A handheld electronic multi-role identification authenticator providing a plurality of dynamic authentication codes associated with a plurality of service providers comprising:
a keypad unit operable to receive key inputs;
a display unit operable to display codes;
a plurality of foils, each foil storing a first secret key, a first communication key, and a plurality of dynamic variables; and
a computing unit operable to generate a plurality of dynamic authentication codes in accordance with a predetermined algorithm, each dynamic authentication code generated based on the first secret key and the dynamic variables stored on one of said foils.

2. The handheld electronic multi-role identification authenticator of claim 1, wherein the service provider provides the first secret key encrypted using a second communication key corresponding to the first communication key according to a first cryptology scheme, and
wherein the authenticator decrypts the first secret key using the first communication key and stores the first secret key in the foil associated with the service provider.

3. The handheld electronic multi-role identification authenticator of claim 1, further comprising:
a storage unit operable to store a second secret key and a third communication key, wherein the second secret key and the third communication key are predetermined by a manufacturer of the authenticator and known by a server of the authenticator.

4. The handheld electronic multi-role identification authenticator of claim 3,
wherein the server of the authenticator provides maintenance information encrypted using a fourth communication key corresponding to the third communication key according to a second cryptology scheme, and
wherein the authenticator decrypts the maintenance information using the third communication key and stores the maintenance information in the storage unit.

5. The handheld electronic multi-role identification authenticator of claim 2, wherein the first cryptology scheme is a symmetric scheme, wherein the first communicate key is identical to the second communication key.

6. The handheld electronic multi-role identification authenticator of claim 2, wherein the first cryptology scheme is an asymmetric scheme, wherein the first communicate key is a private key of the asymmetric scheme and the second communication key is a public key of the asymmetric scheme.

7. The handheld electronic multi-role identification authenticator of claim 3, wherein the second cryptology scheme is a symmetric scheme, wherein the third communicate key is identical to the fourth communication key.

8. The handheld electronic multi-role identification authenticator of claim 3, wherein the second cryptology scheme is an asymmetric scheme, wherein the third communication key is a private key of the asymmetric scheme and the fourth communication key is a public key of the asymmetric scheme.

9. The handheld electronic multi-role identification authenticator of claim 3, wherein the manufacturer provides the server of the authenticator.

10. The handheld electronic multi-role identification authenticator of claim 1, wherein the storage unit is further operative to store a public name of the authenticator, wherein the public name of the authenticator is maintained by a server of the authenticator.

11. The handheld electronic multi-role identification authenticator of claim 1, further comprising:
a communication unit operable to communicate over a communication channel;

12. The handheld electronic multi-role identification authenticator of claim 1, further comprising:
a biometric unit operable to receive biometric information for authentication.

13. The handheld electronic multi-role identification authenticator of claim 1, wherein one of the dynamic variables is a trace variable.

14. The handheld electronic multi-role identification authenticator of claim 13, wherein the trace variable is a time-based variable updated periodically when a predetermined time has elapsed according to a predetermined method.

15. The handheld electronic multi-role identification authenticator of claim 13, wherein the trace variable is an event-based variable updated when a predetermined event has occurred according to a predetermined method.

16. The handheld electronic multi-role identification authenticator of claim 1, wherein one of the dynamic variables is an action variable updated when the authenticator performs a predetermined action according to a predetermined method.

17. The handheld electronic multi-role identification authenticator of claim 16, wherein each foil is further operable to store a plurality of static data maintained by the service provider.

18. The handheld electronic multi-role identification authenticator of claim 16, wherein one of the static data is a public name of the foil.

19. The handheld electronic multi-role identification authenticator of claim 16, wherein one of the static data is a PIN of the foil.

20. A method of a service provider authenticating using a handheld electronic multi-role authenticator associated with a plurality of service providers, comprising:
receiving from the authenticator a first dynamic authentication code generated based on a plurality of dynamic variables and a secret key using a predetermined algorithm;
generating a first dynamic verification code generated based on the dynamic variables and the secret key using the predetermined algorithm;
comparing the first dynamic authentication code to the first dynamic verification code; and
determining authenticity based on a result of the comparison,
wherein the secret key is generated by the service provider and the plurality of dynamic variables is maintained by the service provider.

21. The method of claim 20, wherein the determining comprises:
authenticating if the first dynamic authentication code is identical to the first dynamic verification code.

22. The method of claim 21, wherein the determining comprises:
a) varying the dynamic variables in a first predetermined range if the first dynamic authentication code is not identical to the first dynamic verification code;
b) generating a new authentication code based on the varied dynamic variables and the secret key using the predetermined algorithm;
c) comparing the first dynamic authentication code to the new dynamic verification code;
d) authenticating if the first dynamic authentication code is identical to the new dynamic verification code;
e) repeating steps a)-d) if the first dynamic authentication code is not identical to the new dynamic verification code;
f) rejecting if the first dynamic authentication code is outside a second predetermined range; and
g) requesting a second dynamic authentication code from the authenticator if the first dynamic authentication code is not identical to all new dynamic verification codes generated in the first predetermined range.

23 The method of claim 22, wherein the requesting comprises:
sending by the service provider a request for the second dynamic authentication code to the authenticator, said request containing command and data for setting the dynamic variables maintained by the service provider;
setting the dynamic variables in the authenticator based on the command and data contained in the request;
generating the second dynamic authentication code based on the set dynamic variables and sending the new dynamic authentication code to the service provider; and
determining authenticity of the second dynamic authentication code by the service provider.

24. The method of claim 23, wherein the determining authenticity of the second dynamic authentication code comprises:
receiving from the authenticator the second dynamic authentication code generated based on the reset dynamic variables and the secret key using the predetermined algorithm;
generating a second dynamic verification code generated based on the reset dynamic variables and the secret key using the predetermined algorithm;
comparing the second dynamic authentication code to the second dynamic verification code;
authenticating if the second dynamic authentication code is identical to the second dynamic verification code; and
rejecting if the second dynamic authentication code is not identical to the second dynamic verification code.

25. The method of claim 21, wherein the authenticating is with respect to authenticating an identity of the user of the authenticator and wherein the predetermined algorithm is an identity authenticating algorithm.

26. The method of claim 21, wherein the authenticating is with respect to the authenticating an electronic signature of the user of the authenticator and wherein the predetermined algorithm is a signature authenticating algorithm.

27. A method of authentication for conducting a transaction using a handheld electronic multi-role authenticator associated with a plurality of service providers, comprising:
providing a dynamic authentication code associated with a service provider;
providing a public name associated with the authentication code;
identifying a server of the service provider based on the public name; and
authenticating the dynamic authentication code with the identified server of the service provider.

28. The method of claim 27, wherein the authenticating comprising:
receiving from the authenticator a first dynamic authentication code generated based on a plurality of dynamic variables and a secret key using a predetermined algorithm;
generating a first dynamic verification code generated based on the dynamic variables and the secret key using the predetermined algorithm;
comparing the first dynamic authentication code to the first dynamic verification code; and
determining authenticity based on a result of the comparison,
wherein the secret key is generated by the service provider and the plurality of dynamic variables is maintained by the service provider.

29. The method of claim 28, wherein the determining comprises:
authenticating if the first dynamic authentication code is identical to the first dynamic verification code.

30. The method of 28, wherein the determining comprises:
a) varying the dynamic variables in a first predetermined range if the first dynamic authentication code is not identical to the first dynamic verification code;
b) generating a new authentication code based on the varied dynamic variables and the secret key using the predetermined algorithm;
c) comparing the first dynamic authentication code to the new dynamic verification code;
d) authenticating if the first dynamic authentication code is identical to the new dynamic verification code;
e) repeating steps a)-d) if the first dynamic authentication code is not identical to the new dynamic verification code;
f) rejecting if the first dynamic authentication code is outside a second predetermined range; and
g) requesting a second dynamic authentication code from the authenticator if the first dynamic authentication code is not identical to all new dynamic verification codes generated in the first predetermined range.

31. The method of 30, wherein the requesting comprises:
sending by the service provider a request for the second dynamic authentication code to the authenticators said request containing command and data for setting the dynamic variables maintained by the service provider;
setting the dynamic variables in the authenticator based on the command and data contained in the request;
generating the second dynamic authentication code based on the set dynamic variables and sending the new dynamic authentication code to the service provider; and
determining authenticity of the second dynamic authentication code by the service provider.

32. The method of claim 31, wherein the determining authenticity of the second dynamic authentication code comprises:
receiving from the authenticator the second dynamic authentication code generated based on the reset dynamic variables and the secret key using the predetermined algorithm;
generating a second dynamic verification code generated based on the reset dynamic variables and the secret key using the predetermined algorithm;
comparing the second dynamic authentication code to the second dynamic verification code; and
authenticating if the second dynamic authentication code is identical to the second dynamic verification code; and
rejecting if the second dynamic authentication code is not identical to the second dynamic verification code.

33. The method of claim 28, wherein the authenticating is with respect to authenticating an identity of the user of the authenticator and wherein the predetermined algorithm is an identity authenticating algorithm.

34. The method of claim 28, wherein the authenticating is with respect to the authenticating an electronic signature of the user of the authenticator and wherein the predetermined algorithm is a signature authenticating algorithm.

35. A program storage device readable by a machine, tangibly embodying a program of instructions executable by the machine to perform a method of a service provider authenticating using a handheld electronic multi-role authenticator associated with a plurality of service providers, comprising:
receiving from the authenticator a first dynamic authentication code generated based on a plurality of dynamic variables and a secret key using a predetermined algorithm;
generating a first dynamic verification code generated based on the dynamic variables and the secret key using the predetermined algorithm;
comparing the first dynamic authentication code to the first dynamic verification code; and
determining authenticity based on a result of the comparison,
wherein the secret key is generated by the service provider and the plurality of dynamic variables is maintained by the service provider.

36. The program storage device of claim 35, wherein the determining comprises:
authenticating if the first dynamic authentication code is identical to the first dynamic verification code.

37. The program storage device of claim 36, wherein the determining comprises:
a) varying the dynamic variables in a first predetermined range if the first dynamic authentication code is not identical to the first dynamic verification code;
b) generating a new authentication code based on the varied dynamic variables and the secret key using the predetermined algorithm;
c) comparing the first dynamic authentication code to the new dynamic verification code;
d) authenticating if the first dynamic authentication code is identical to the new dynamic verification code;
e) repeating steps a)-d) if the first dynamic authentication code is not identical to the new dynamic verification code;
f) rejecting if the first dynamic authentication code is outside a second predetermined range; and
g) requesting a second dynamic authentication code from the authenticator if the first dynamic authentication code is not identical to all new dynamic verification codes generated in the first predetermined range.

38. The program storage device of claim 37, wherein the requesting comprises:
sending by the service provider a request for the second dynamic authentication code to the authenticator, said request containing command and data for setting the dynamic variables maintained by the service provider;
setting the dynamic variables in the authenticator based on the command and data contained in the request;
generating the second dynamic authentication code based on the set dynamic variables and sending the new dynamic authentication code to the service provider; and
determining authenticity of the second dynamic authentication code by the service provider.

39. The program storage device of claim 38, wherein the determining authenticity of the second dynamic authentication code comprises:
receiving from the authenticator the second dynamic authentication code generated based on the reset dynamic variables and the secret key using the predetermined algorithm;
generating a second dynamic verification code generated based on the reset dynamic variables and the secret key using the predetermined algorithm;
comparing the second dynamic authentication code to the second dynamic verification code;
authenticating if the second dynamic authentication code is identical to the second dynamic verification code; and
rejecting if the second dynamic authentication code is not identical to the second dynamic verification code.

40. The program storage device of claim 36, wherein the authenticating is with respect to authenticating an identity of the user of the authenticator and wherein the predetermined algorithm is an identity authenticating algorithm.

41. The program storage device of claim 36, wherein the authenticating is with respect to the authenticating an electronic signature of the user of the authenticator and wherein the predetermined algorithm is a signature authenticating algorithm.
